(19) United States
(12) Patent Application Publication
(10) Pub. No.: US 2019/0315567 A1
(43) Pub. Date: Oct. 17, 2019

(54) POLYMERIC BAGS AND METHOD TO MAKE SAME

(71) Applicant: Poly-America, L.P., Grand Prairie, TX (US)

(72) Inventor: Brad A. Cobler, Irving, TX (US)

(21) Appl. No.: 15/954,687

(22) Filed: Apr. 17, 2018

(51) Int. Cl. B65F 1/00; B65D 33/28; B32B 27/32; B32B 27/08; B32B 37/00; B32B 38/06; B32B 3/30; B29D 22/00; B29C 59/04

(52) U.S. Cl. CPC B65F 1/0006; B29L 2031/7128; B32B 27/32; B32B 27/08; B32B 37/0076; B32B 38/06; B32B 3/30; B29D 22/003; B29C 59/046; B65F 2250/1143; B32B 2250/02; B32B 2250/242; B32B 2323/043; B32B 2323/046; B32B 2439/06; B32B 2307/5825; B29K 2995/0081; B65D 33/28

(57) ABSTRACT

The present invention is directed to a multilayer bag with one or more embossed layers of polymeric film and a method to form the same. The embossed layers may provide improved shock resistance, tear resistance, and allow the bag to easily stretch and expand. Each layer of the polymeric bag may be embossed separately and then combined into a multilayer web. For certain embodiments, only one layer of the multilayer bag may be embossed. The individual layers may be formed from opposing sides of a collapsed tube of polymeric film or be formed from two distinct collapsed tubes of polymeric film. The polymeric bag may be a drawstring trash bag with the embossed pattern only extending a partial height of the bag.

### CROSS-REFERENCE TO RELATED APPLICATIONS

Not applicable.

### BACKGROUND OF THE INVENTION

### 1. Field of the Invention

The present invention relates to improvements in the construction and manufacture of polymeric film and bags. In particular, the present invention relates to improvements in multilayer trash bags formed from a blown film extrusion process.

### 2. Description of the Related Art

Polymeric bags are ubiquitous in modern society and are available in countless combinations of varying capacities, thicknesses, dimensions, and colors. The bags are available for numerous applications including typical consumer applications such as long-term storage, food storage, and trash collection. Like many other consumer products, increased demand and new technology have driven innovations in polymeric bags improving the utility and performance of such bags. The present invention is an innovation of particular relevance to polymeric bags used for trash collection.

Polymeric bags are manufactured from polymeric film produced using one of several manufacturing techniques well-known in the art. The two most common methods for manufacture of polymeric films are blown-film extrusion and cast-film extrusion. In blown-film extrusion the resulting film is tubular while cast-film extrusion produces a generally planar film. Manufacturing methods for the production of drawstring bags from a web of material are shown in numerous prior art references including, but not limited to, U.S. Pat. Nos. 3,196,757 and 4,624,654, which are hereby incorporated by reference. In blown film extrusion, the direction that the film is extruded is commonly referred to as the machine direction (MD) and the direction perpendicular to the machine direction is commonly referred to as the cross direction (CD).

Drawstring trash bags are frequently used in connection with rigid containers. When used with a rigid container, it is common to fold the upper opening of a drawstring trash bag over the upper rim of the container to keep the upper opening of the bag accessible. Some rigid containers provide retaining devices to hold the upper opening of a drawstring bag in place while, in other instances, the drawstring bag may provide certain features or properties that facilitate keeping the bag in place on the container. The use of these rigid containers is particularly common in connection with 13-gallon drawstring bags typically used in the household or in an office environment. Rigid containers may also be used with larger bags, such as those commonly used for the collection of outdoor or yard waste. When drawstring bags are used with supporting rigid containers, the drawstring trash bag is often filled with trash and other debris until the capacity of the container or trash bag is reached.

Use of polymeric film presents technical challenges since polymeric film is inherently soft and flexible. Specifically, all polymeric films are susceptible to puncture and tear propagation. In some instances, it may be possible to increase the thickness of the film or select improved polymers to enhance the physical properties of the film. However, these measures increase both the weight and cost of the polymeric film and may not be practicable. In light of the technical challenges of polymeric film, techniques and solutions have been developed to address the need for improved shock absorption to reduce the likelihood of puncture and also to increase the tear resistance of polymeric films.

U.S. Pat. No. 5,205,650, issued to Rasmussen and entitled Tubular Bag with Shock Absorber Band Tube for Making Such Bag, and Method for its Production, discloses using polymeric film material with stretchable zones wherein the film material has been stretched in a particular direction with adjacent un-stretched zones that extend in substantially the same direction. The combination of the stretched zones and adjacent un-stretched zones provides a shock absorber band intended to absorb energy when the bag is dropped. Specifically, when a bag is dropped or moved, the contents inside the bag exert additional forces that would otherwise puncture or penetrate the polymeric film. However, the shock absorber bands absorb some of the energy and may prevent puncture of the film.

Another example of a polymeric film material designed to resist puncture is disclosed in U.S. Pat. No. 5,518,801, issued to Chappell and entitled Web Materials Exhibiting Elastic-Like Behavior. Chappell, in the aforementioned patent and other related patents, discloses using a plurality of ribs to provide stretchable areas in the film much like Rasmussen. Chappell also discloses methods of manufacturing such polymeric film with such ribs.

Another example of shock absorption to prevent puncture is disclosed in U.S. Pat. No. 5,650,214 issued to Anderson and entitled Web Materials Exhibiting Elastic-Like Behavior and Soft Cloth-Like Texture. Anderson discloses using a plurality of embossed ribs defining diamond-shaped areas with a network of unembossed material between the diamond-shaped areas. Thus, the unembossed area comprises a network of straight, linear unembossed material extending in two perpendicular directions.

The foregoing disclosures specifically address the desire to increase the shock absorption of polymeric film to reduce the likelihood of punctures occurring in the film. However, none of the foregoing disclosures address the problem of reducing tear propagation in the polymeric film of a bag.

Previously known solutions to limiting tear propagation are based on two primary concepts. First, longer and more tortuous tear paths consume more energy as the tear propagates and can help in limiting the impact of the tear in a bag or polymeric film. Second, many polymeric films, particularly polymeric films made using a blown-film extrusion process, have different physical properties along different axes of the film. In particular, blown films are known to have higher tear strength in the cross-direction versus the corresponding tear strength in the machine direction. Certain prior art solutions take advantage of the differential properties of polymeric films by redirecting tears into a different direction. This redirecting of tears can offer greater resistance to a tear propagating. For example, some solutions redirect a tear propagating in the weaker machine direction of blown film into the stronger cross-direction.

One solution for reducing tear propagation is based on the idea that longer, tortuous tear paths are preferable and is described in U.S. Pat. No. 6,824,856, issued to Jones and entitled Protective Packaging Sheet. Jones discloses materials suitable for packaging heavy loads by providing an embossed packaging sheet with improved mechanical properties. Specifically, a protective packaging sheet is disclosed where surfaces of the sheet material are provided with protuberances disposed therein with gaps between protuberances. The protuberances are arranged such that straight lines necessarily intersect one or more of the protuberances. The resulting protective packaging sheet provides mechanical properties where tears propagating across the polymeric sheet are subject to a tortuous path. The tortuous path is longer, and more complex, than a straight-line tear, and a tear propagating along such a path would require markedly more energy for continued propagation across the film compared to a tear along a similar non-tortuous path in the same direction. Thus, due to the increased energy required for tear propagation, the tortuous path ultimately reduces the impact of any tears that do propagate across the film.

Another example of a tear resistant plastic film is disclosed in U.S. Pat. No. 8,357,440 to George M. Hall with a filing date of Jun. 29, 2007 and entitled Apparatus and Method for Enhanced Tear Resistance Plastic Sheets, which is herein incorporated by reference into this disclosure. Hall discloses an alternative tortuous path solution and further relies on the fact discussed above that certain polymer films, particularly polymeric films made in a blown-film extrusion process, are known to have a stronger resistance to tear in the cross direction in comparison to the machine direction.

Hall discloses a solution that contemplates using preferably shaped embosses, particularly convex shaped embosses with a curved outer boundary, to provide maximum resistance to tear propagation. In most polymeric films, a tear will have a tendency to propagate along the path of least resistance or in the machine direction. Hall contemplates redirecting propagating tears in a tortuous path with the additional intent of redirecting the machine direction tears along the curved edges of the embossed regions and into a cross direction orientation. The redirected tears in the cross direction will be subject to additional resistance and, preferably, will propagate to a lesser degree than a tear propagating in the machine direction in an unembossed film.

U.S. Pat. No. 9,290,303 to Brad A. Cobler (the '303 patent) with a filing date of Oct. 24, 2013 and entitled Thermoplastic Films with Enhanced Resistance to Puncture and Tear, herein incorporated by reference into this disclosure, discloses use of an embossing pattern. This embossing pattern applied to polymeric film balances both properties of shock absorption and tortuous tear paths in the cross direction. The patent discloses that the embossing pattern comprises a plurality of embossed regions comprised of a plurality of parallel, linear embosses. The plurality of embossed regions is arranged so that a straight line cannot traverse the polymeric film without intersection at least one of the plurality of embossed regions.

U.S. Pat. No. 9,546,277 to Brad A. Cobler (the '277 patent), with a filing date of Mar. 23, 2015, and also entitled Thermoplastic Films with Enhanced Resistance to Puncture, herein incorporated by reference into this disclosure, discloses various improvements to the embossing pattern disclosed by the '303 patent. The '303 patent and '277 patents may be collectively referred to as the Cobler patents.

Another method to improve the tear and puncture resistance of trash bags may be to construct the bag from multiple layers of polymeric film. Under certain conditions, two or more layers of film may provide improved tear and strength properties in comparison to a single layer of film with a comparable thickness. For instance, thinner layers of film formed by blown film extrusion can lead to increased machine direction orientation due to an increased draw down ratio. The increased machine direction orientation can result in increased machine direction tensile strength and thus increase the burst strength of bags formed from multiple layers of thin film versus a single layer of film of comparable thickness.

An increased draw down ratio is also known to improve cross direction tear strength due to the increased machine direction orientation as may be the result of extruding thinner layers of film. In contrast to this, the embossing pattern of the Cobler patents when applied to flex the film in the cross direction is known to improve machine direction tear strength and decrease cross direction tear strength. Thus, the use of multiple layers of thin film can work in tandem with the embossing pattern of the Cobler patents applied to the film layers. The increased cross direction tear strength of the thinner layers can offset the decrease in cross direction tear strength due to use of the Cobler embossing pattern.

U.S. patent application Ser. No. 15/712,543 to Gregory James Wood, with a filing date of Sep. 22, 2017 and entitled Polymeric Bags and Method to Make Same, herein incorporated by reference into this disclosure, discloses a multilayer bag formed by a single continuous collapsed tube. However, because the Wood application discloses making a multilayer bag from a single continuous multilayer tube, the amount that one particular layer can be modified in comparison to another layer is constrained.

A further advantage of constructing the bag with multiple layers when each layer is a separate single layer web is that each layer may undergo various post extrusion processes to enhance the properties of the individual layers. For example, one or both of the layers may have one or more of the embossing patterns applied to it, as disclosed in the Cobler patents, to tailor the tear strength, tensile strength, and stretching properties of the bag for particular applications.

In light of the foregoing, it would be desirable to provide a method of efficiently manufacturing bags comprised of panels having multiple layers where each layer is from a single layer web. It would also be desirable to provide trash bags with multiple layers with one or more of the embossing patterns as disclosed by the Cobler patents. A bag with one or more of these patterns applied to one or more layers may provide a trash bag with improved shock absorption, improved lifting capacity, and resistance to tear propagation in comparison to the state of the art trash bags. The present invention addresses these objectives.

### SUMMARY OF THE INVENTION

In one embodiment of the present invention, a multilayer bag may comprise a front panel and a rear panel. The front panel and rear panel may be joined adjacent to a first side edge by a first side seal and adjacent to an opposite second side edge by a second side seal. The front and rear panels may each comprise inner and outer layers of polymeric film. The inner and outer layers may be formed from first and second single layer webs. The first and second single layer webs may be folded generally along a centerline extending in the machine direction to form a bottom edge of the multilayer bag. The first single layer web may be folded within the second single layer web. The first and second layers may each have an embossed pattern and each embossed pattern may be formed separately such that the embossed patterns are offset and not intermeshed with each other. The front panel and rear panel may be joined at a bottom edge. An opening of the bag may be defined by an upper edge of the front and rear panels.

In certain embodiments, the first and second single layer webs may be formed from a single collapsed tube of polymeric film and the collapsed tube may be formed by blown film extrusion. In further embodiments of the invention, the first and second single layer webs may be formed from two separate collapsed tubes of polymeric film. The first embossed pattern may be different from the second embossed pattern. The first embossed pattern may have a different depth of engagement from the second embossed pattern. The first and second embossed patterns may extend continuously from the first side edge to the second side edge of the multilayer bag. The first and second embossed patterns may have first and second heights, the first height different from the second height.

In another embodiment of the invention, a multilayer bag may comprise a front panel and a rear panel. The front panel and rear panel may be joined adjacent to a first side edge by a first side seal and adjacent to an opposite second side edge by a second side seal. The front and rear panels may each comprise first and second layers of polymeric film and the first and second layers may be formed from separate first and second single layer webs. Each of the single layer webs may be formed from one or more collapsed tubes of polymeric film. Each of the single layer webs may further have a centerline extending in the machine direction. Only one of the first and second layers of the front and rear panels may have an embossed pattern. The front panel and rear panels may be joined at a bottom edge and the bottom edge may correspond generally to the centerline of the first and second webs. An opening of the multilayer bag may be defined by an upper edge of the front and rear panels.

In certain embodiments, the one or more collapsed tubes may be formed by blown film extrusion. In further embodiments, the one or more collapsed tubes may comprise first and second collapsed tubes and each collapsed tube may be slit and unfolded to form one of the first and second single layer webs. In other embodiments, the first and second single layer webs may be formed from a single collapsed tube. The embossed pattern may extend continuously in the machine direction and the embossed pattern may comprise a flexing embossed pattern. The embossed pattern may only extend a partial height of the multilayer bag. Additionally, the embossed pattern may comprise at least two separate partial heights of the multilayer bag.

In a further embodiment of the invention, a multilayer polymeric bag may be formed. A first web of continuous film may be embossed with a first embossed pattern. The first web may only be a single layer and have a machine direction and a cross direction. The first web may have a first edge opposite from a second edge in the cross direction and have a first web width extending in the cross direction. After the first web is embossed, a second web of continuous film may be placed over the first web. The second web may be only a single layer and have a machine direction and a cross direction. The second web may have a first edge opposite from a second edge in the cross direction and have a second web width extending in the cross direction. The first web may be overlaid with the second web so that the first edges of the first and second webs are adjacent to each other and the second edges of the first and second webs are adjacent to each other. The overlaid first and second webs may be folded in half so that a centerline in the machine direction of both webs generally corresponds with the fold formed in the first and second webs. The first and second folded webs may then be converted into bags.

In at least certain embodiments, the converting of the bags may include defining a bottom edge of the bags at the centerline of both webs. The converting may further comprise placing a plurality of pairs of transverse seals in the folded webs to define side seals. A plurality of perforations may be placed between each pair of side seals to define side edges of the bags. In further embodiments, the embossing of the first web may extend only a partial width of the first web width. The embossing of the first web may comprise at least two separate partial widths of the first web width. The first and second single layer webs may be formed from a single collapsed tube of blown polymeric film. In further embodiments, the first and second single layer webs may be formed from two different collapsed tubes of blown polymeric film. Additionally, the second web of continuous film may be embossed separately from the first web.

### BRIEF DESCRIPTION OF THE RELATED DRAWINGS

A full and complete understanding of the present invention may be obtained by reference to the detailed description of the present invention and certain embodiments when viewed with reference to the accompanying drawings. The drawings can be briefly described as follows.

FIG. 1A provides a perspective view of a first embodiment of the present invention.

FIG. 1B provides a cross-section view of the first embodiment of the present invention taken along line B-B of FIG. 1.

FIG. 2 provides a perspective view of the second embodiment of the present invention.

FIG. 3 provides perspective view of a third embodiment of the present invention.

FIG. 4 provides a top schematic view of an embossed pattern utilized by the present invention.

FIG. 5 provides a perspective view of an embossing operation of the present invention.

FIG. 6 provides a perspective view of an embossing roller surface of FIG. 5.

FIG. 7 provides a perspective view of a converting process of the present invention.

FIG. 8 provides a cross section view of a bag formed by the converting process of FIG. 7 taken along line D-D of FIG. 7.

FIG. 9A provides a perspective view of the bag of FIG. 8.

FIG. 9B provides a perspective view of another bag formed by the converting process of FIG. 7.

FIG. 10A provides a front view of the bag of FIGS. 8 and 9A.

FIG. 10B provides a front view of the bag of FIG. 9B.

FIG. 11A provides an enlarged view of a portion of FIG. 10A as indicated by broken line box 10.

FIG. 11B provides a cross-section view taken along line E-E of FIG. 11A.

FIG. 12A provides an enlarged view of a portion of FIG. 10B as indicated by broken line box 11.

FIG. 12B provides a cross-section view taken along line F-F of FIG. 11A.

FIG. 13 provides a top schematic view of an additional embossed pattern of the present invention.

### DETAILED DESCRIPTION OF THE INVENTION

The present disclosure illustrates several embodiments of the present invention. It is not intended to provide an illustration or encompass all embodiments contemplated by the present invention. In view of the disclosure of the present invention contained herein, a person having ordinary skill in the art will recognize that innumerable modifications and insubstantial changes may be incorporated or otherwise included within the present invention without diverging from the spirit of the invention. Therefore, it is understood that the present invention is not limited to those embodiments disclosed herein. The appended claims are intended to more fully and accurately encompass the invention to the fullest extent possible, but it is fully appreciated that certain limitations on the use of particular terms are not intended to conclusively limit the scope of protection.

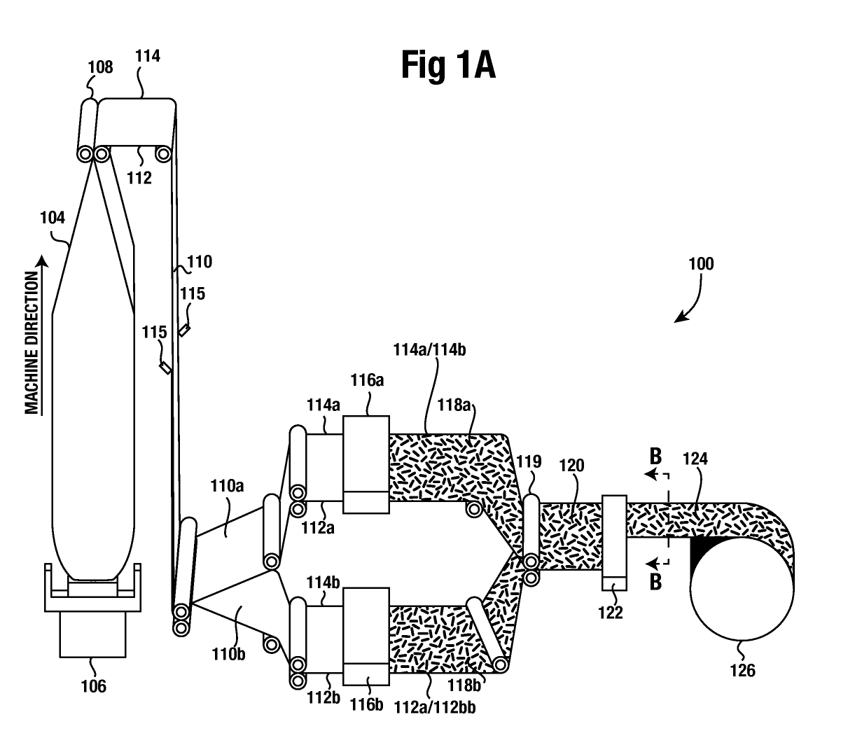

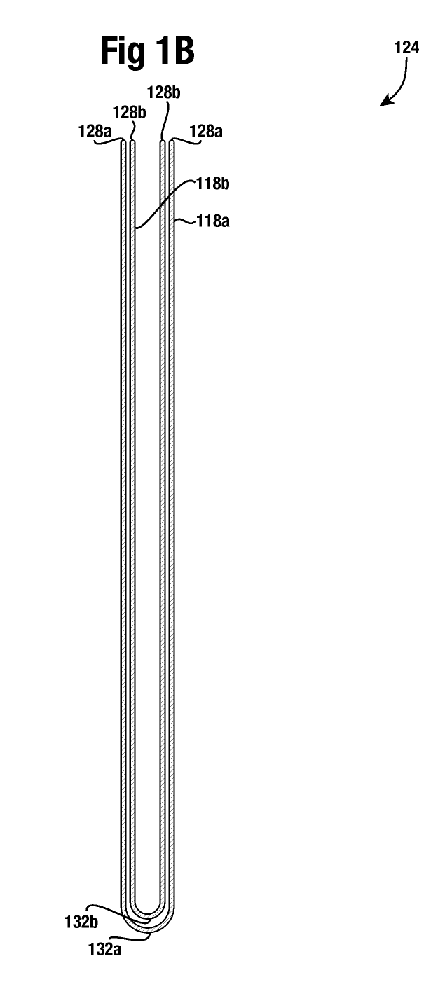

FIG. 1A provides a perspective view of a first embodiment of the present invention. The first embodiment is a process for forming an embossed multilayer folded web. Once the process is completed, a folded four layer web is provided with each layer having an embossed pattern applied. Upper and lower halves of a polymeric tube are divided lengthwise and separately embossed by separate embossing operations. The polymeric film tube, which may also be referred to as a bubble, is formed by a blown film extrusion process.

The multilayer web forming process 100 begins by molten polymeric resin being extruded through an annular die of extruder 106 to form a bubble or tube of molten polymeric film 104. The direction that the film is extruded out of the die is commonly referred to as the machine direction as shown by FIG. 1A, such that the length of the polymeric tube 104 extends parallel with the machine direction. The direction transverse or perpendicular to the machine direction is commonly referred to as the cross direction. The blown film extrusion process is well known in the art and is further explained in U.S. Pat. No. 7,753,666, issued to Greg A. Wood and having a filing date of Jun. 12, 2006, which is hereby incorporated by reference in its entirety.

The polymeric resin used in the blown film extrusion process may vary. However, for forming polymeric bags, a polyethylene resin is commonly used. In the current state of the art for polymeric bags, a blend of various polyethylene polymers may be used. A polymer blend can have linear low-density polyethylene (LLDPE) as the primary component, but other polymers may be utilized including, but not limited to, other polyethylene resins such as high-density polyethylene (HDPE) or low-density polyethylene (LDPE). Typically, the primary component of the polymer blend, such as linear low-density polyethylene (LLDPE), will comprise at least 75% of the polymer blend. The remaining portion of the polymer blend may include additives including, but not limited to, coloring additives such as TiO2 and carbon black, anti-blocking agents, and/or odor control additives.

As shown in FIG. 1A, once the bubble 104, or polymeric tube, of molten film solidifies, the bubble 104 is collapsed by a pair of nip rollers 108, which results in a collapsed bubble or tube 110. The collapsed bubble 110 includes two opposing interconnected layers of film extending continuously in a lengthwise direction. Once collapsed, the collapsed bubble 110 has a first edge 112 and opposing second edge 114 extending the length of collapsed bubble 110 with opposing first and second sides of film, each side comprising a single layer. The distance from the first edge 112 to the second edge 114 of the collapsed bubble 110 defines a width of the collapsed bubble. The nip rollers 108 are commonly elevated above the extruder 106 a considerable distance, since the molten bubble 104 is air-cooled and requires a relatively large vertical distance to cool and solidify before the bubble 104 is collapsed. Once the collapsed bubble 110 returns from the cooling tower (not shown), the collapsed bubble 110 can be slit at opposing edges 112 and 114 by a slitting operation 115 to separate the two opposing sides into two single layer webs.

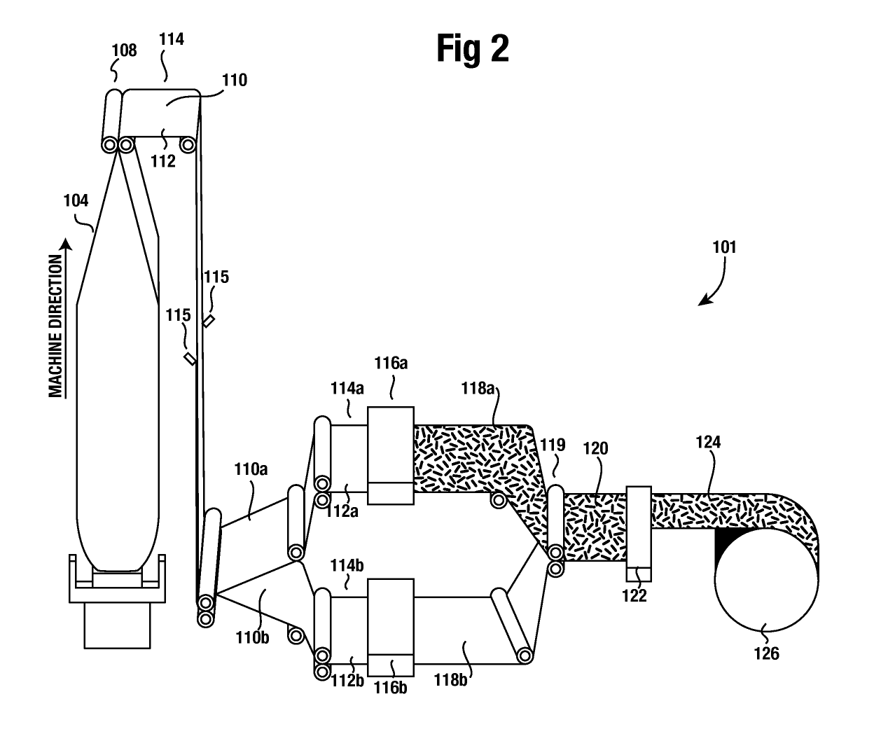

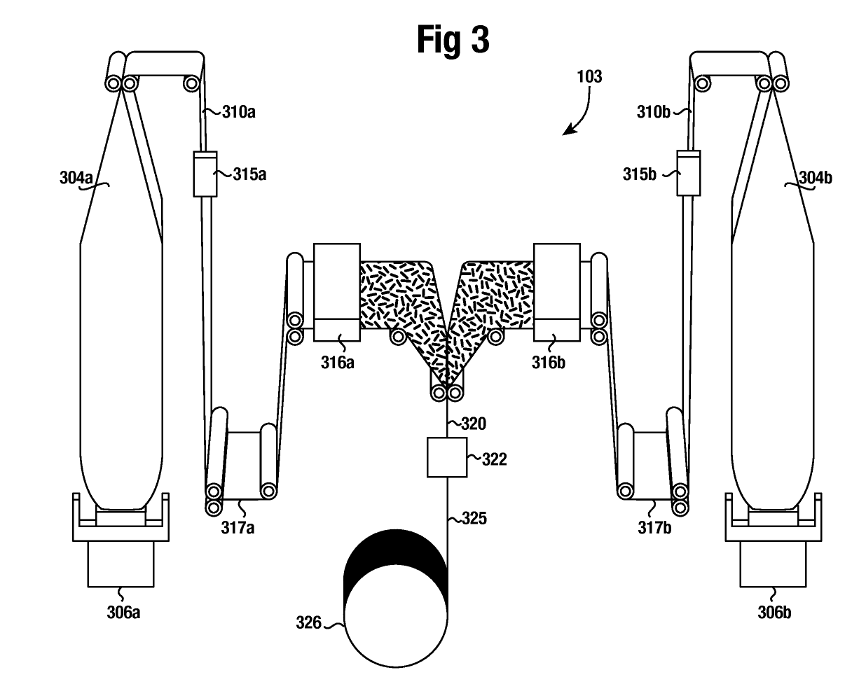

Once the collapsed tube or bubble 110 is slit by slitting operation 115, the individual layers of the two opposing sides of the collapsed tube 110 can be separated into first and second single layer webs 110a and 110b with first web 110a having opposing edges 112a and 114a and second web 110b having opposing edges 112b and 114b. These two layers can be separated by various methods as known to one skilled in the art. Each of the webs 110a and 110b can then be embossed separately with first web 110a embossed by first embosser 116a and second web embossed by second embosser 116b. After the embossing is complete, first and second single layer embossed webs 118a and 118b can be formed. As shown by FIG. 1A, as well as in FIGS. 2 and 3, the embossed pattern on webs 118a and 118b is illustrated by a generalized pattern for ease of illustration.

As further shown by FIG. 1A, the two embossed webs 118a and 118b may be overlaid onto each other to form a two layer web 120 such that edge 112a is adjacent to edge 112b and edge 114a is adjacent to 114b. The two embossed webs 118a and 118b may be overlaid with each other by a pair of merging rollers 119. In addition to the rollers as illustrated in FIG. 1A, various types of edge control may be utilized, as is commonly known to one of ordinary skill, to control the location of webs 118a and 118b. At least in certain preferred embodiments, although the two single layer embossed webs 118a and 118b are overlaid with each other, it is not expected for the two layers to be laminated or bonded to each other because only minimum pressure is applied to the two webs when overlaid with each other and no other operation is performed to bond or laminate the two webs together.

Once the two webs 118a and 118b are overlaid with each other, the two layer web 120 can be folded in half about a centerline of the two webs by folding operation 122. As shown by FIG. 1B, a schematic cross-section of folded embossed webs 118a and 118b, a four layer folded web 124 is formed by folding operation 122. FIG. 1B further shows a pair of distal edges 128a of first web 118a and a pair of distal edges 128b of second web 118b. Opposite from the distal edges 128a and 128b are shown first and second web folds 132a and 132b located where the two webs are folded by the folding operation 122. This location, as discussed above, can generally be along the centerline of the two webs 118a and 118b.

FIG. 1B shows folds at 132a and 132b with curvature solely for the purposes of illustration. It is expected that these folds will be flat with essentially no radius in practice. FIG. 1B further shows a gap between adjacent layers of film for ease of illustration. It is expected that in practice the surfaces of adjacent layers will generally be in contact with each other and have little or no appreciable separation from each other.

Folding operation 122 as illustrated by FIGS. 1A and 1B can comprise folding bars, rollers, edge control, etc. to fold the two layers together as commonly known to one having skill in the art. Once the two layer web is folded together into a folded two layer web 124, it can be rolled into a stock roll 126 as further shown in FIG. 1A.

Shown in FIG. 2 is a further embodiment of a process for forming a multilayer web. Process 101 of FIG. 2 is similar to process 100 of FIG. 1 for forming a multilayer web with likewise reference numbers reflecting shared features. However, unlike the process shown in FIG. 1, the FIG. 2 process illustrates first single web 110a embossed and second single layer web 110b not embossed. In this second embodiment, the second embosser 116b can be disabled or completely removed from the process. Reference is made to the discussion of FIG. 1 regarding the remaining features of FIG. 2.

FIG. 3 shows a further embodiment of a process 103 for forming a multilayer web 300. In this third embodiment, each of the single layer webs 310a and 310b are provided by a different extruder. This arrangement allows for use of different material compositions from each extruder. As shown by FIG. 3, extruder 306a can produce collapsed tube or bubble 310a and extruder 306b can produce collapsed tube or bubble 310b. Collapsed tubes 310a and 310b can pass through a slitting and unfolding operation 315a and 315b which makes a single slit in each corresponding collapsed bubble and unfolds the each collapsed bubble into single layer first and second webs 317a and 317b.

As further shown by FIG. 3, once each double layer tube 310a and 310b are converted into single layer webs 317a and 317b, each of the webs can undergo an embossing operation by embossers 316a and 316b. In an alternative embodiment, only one of the two single layer webs 310a and 310b can be embossed. Once the embossing operation is complete, the two single layer webs can be overlaid, as previously described in regards to FIG. 1, into a multilayer web 320. Multilayer web 320 can then be folded by folder 322 into four layer folded web 325 and then rolled into stock roll 326.

As addressed above, the FIG. 3 embodiment allows each single web to be comprised of different materials. In one particular embodiment, first single layer web 317a can be primarily comprised of a LLDPE while the second single layer web 317b can be primarily comprised of HDPE. In another embodiment, each web 317a and 317b can be comprised of primarily a LLDPE polymer of different densities. The properties of the two layers can also vary by other properties such as melt index and formation properties of the blown film extrusion process such as blow up ratio (BUR) and draw rate. Additional material compositions for each web can be selected, including commercially available LDPE, LLDPE, MLLDPE, and HDPE polymers. Each web can consist of one or more these aforementioned polymers or other commercially available polymers.

As illustrated by FIGS. 1A and 2-3, the extrusion, separation of layers, embossing of the layers, and overlaying of the layers are all performed synchronously by an in-line process. In at least certain embodiments, however, each of these operations may be performed offline or separately from each other. For instance, the collapsed tube may be rolled into a stock roll, the stock roll of the collapsed tube may then be unrolled and separated into layers and embossed. This embossed multilayer web may then be rolled into a stock roll, then unrolled and converted into bags. In another embodiment, the collapsed tube may be slit and separated into two separate layers and rolled into two separate stock rolls. These two separate stock rolls may then be provided to a bag converting operation, where one or more of the single layer webs are embossed as part of the bag converting operation. Once the embossing is complete the two separate layers can be overlaid to form a multilayer web for forming into a plurality of bags.

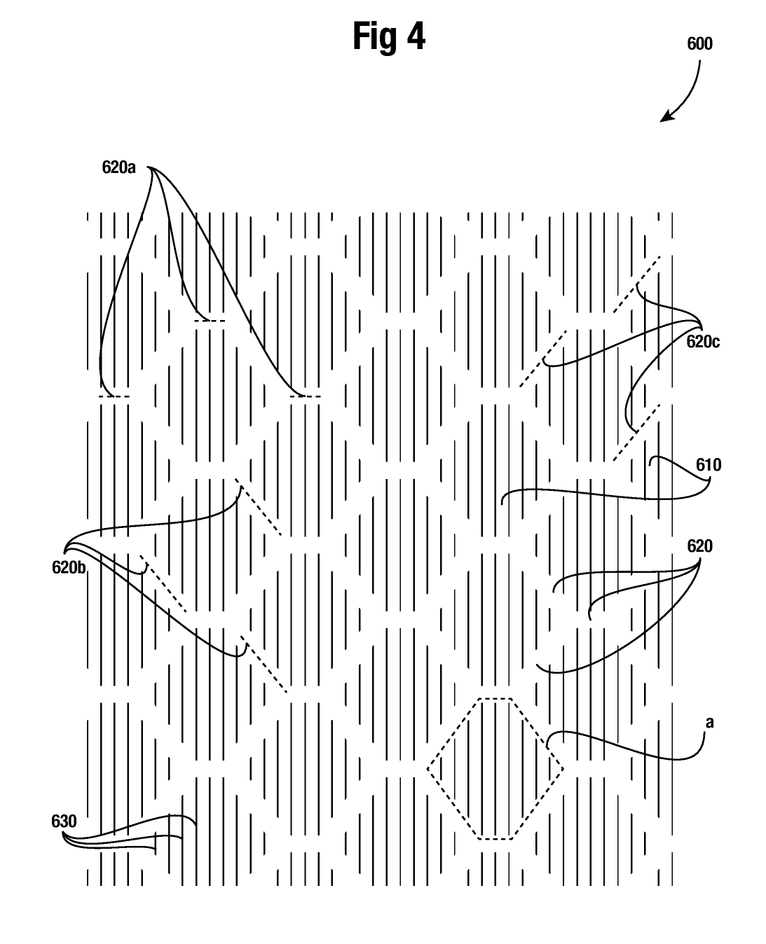

Now turning to FIG. 4, one particular embossed pattern that may be utilized on the above described single layer webs is shown. The embossed pattern of FIG. 4 allows the single layer webs to expand in the cross-direction of the webs to absorb shock. For certain embodiments of the invention, the one or more embossed webs can be converted into drawstring trash bags such that the cross direction of the web is oriented in the lengthwise direction of the trash bags such that the bags expand and stretch in the lengthwise direction, from a bag's bottom edge to its upper opening due to the embossed pattern.

The above-discussed expansion of bags can increase the capacity of the bags when filled with debris. Furthermore, this particular type of embossed pattern can also prevent the propagation of tears due to the tortious path defined by the embossed pattern since a straight line cannot pass through more than one embossed region without intersecting an adjacent embossed region.

FIG. 4 is a detailed schematic view of the aforementioned flexing embossed pattern. The embossed pattern 600 has a plurality of embossed regions 610, each embossed region 610 having a generally hexagonal shape with each embossed region 610 separated by a continuous unembossed arrangement 620. One of the hexagonal shapes is indicated by dashed lines A in FIG. 4. The dashed lines of A are shown for reference only and form no structure of the disclosed invention. Each embossed region 610 is shown as defined by nine parallel and adjacent linear embosses 630. The two opposing horizontally extending sides of each embossed region 610 can be defined by three middle adjacent parallel linear embosses 630 with equal length; each horizontal side of the hexagon formed by adjacent ends of the three linear embosses 630. Each of the other four diagonal sides of the hexagon can be defined by an endpoint of an outer emboss of the three middle adjacent linear embosses 630 and adjacent end points of three other outer adjacent linear embosses 630. Each of the three other adjacent linear embosses 630 can decrease in length the same amount as the adjacent linear emboss 630.

The hexagonal shaped embossed regions 610 of FIG. 4 can be oriented such that opposing vertices of each hexagon are at a left and right side of each hexagon as illustrated in FIG. 4. Adjacent to the vertices can be two short opposing linear embosses 630 at each end of each embossed region 610. These opposing vertices encourage each embossed region to fold-in when the linear embosses unfold in the horizontal direction. Hence, a film with the embossed pattern 600 of FIG. 4 expands in the horizontal direction but not in the vertical direction. This expansion is much greater and at a much lower force than would be required to stretch the unembossed film.

FIG. 4 depicts the unembossed arrangement 620 having a plurality of first segments 620a, a plurality of second segments 620b, and a plurality of third segments 620c. Each embossed region 610 is bounded by two first segments 620a, two second segments 620b, and two third segments 620c. Each first segment 620a extends in a first direction that is generally horizontal. Each second segment 620b extends in a second direction that is oblique to the first direction. Each third segment 620c extends in a third direction that is oblique to both the first direction and the second direction. The first, second, and third directions are all distinct from each other. As shown in FIG. 4, each of the segments 620a, 620b, or 620c are interrupted by an adjacent embossed region 610, failing to extend past more than one embossed region 610.

As further shown in FIG. 4, the first segments 620a intersect both the second segments 620b and third segments 620c. Furthermore, a first segment 620a, a second segment 620b, and a third segment 620c all intersect each other adjacent to both the upper and lower vertices of each embossed region 610. In a particular embodiment of the embossed pattern 600, the angle formed by each intersection by a first segment 620a with a second segment 620b or third segment 620c can be approximately 54 degrees or the supplementary angle of 126 degrees. In the same embodiment, the angle formed by each intersection of a second segment 620b with a third segment 620c can be approximately 108 degrees.

The preferred actual size and spacing of the embossed pattern 600 is substantially exaggerated for ease of illustration in the figures. However, in one preferred embodiment, the spacing of the ridges, or the pitch, can be about 20 ridges per inch about the circumference of the first roller 322a so that each embossed region 610 is about 0.45 0.5 inch in length.

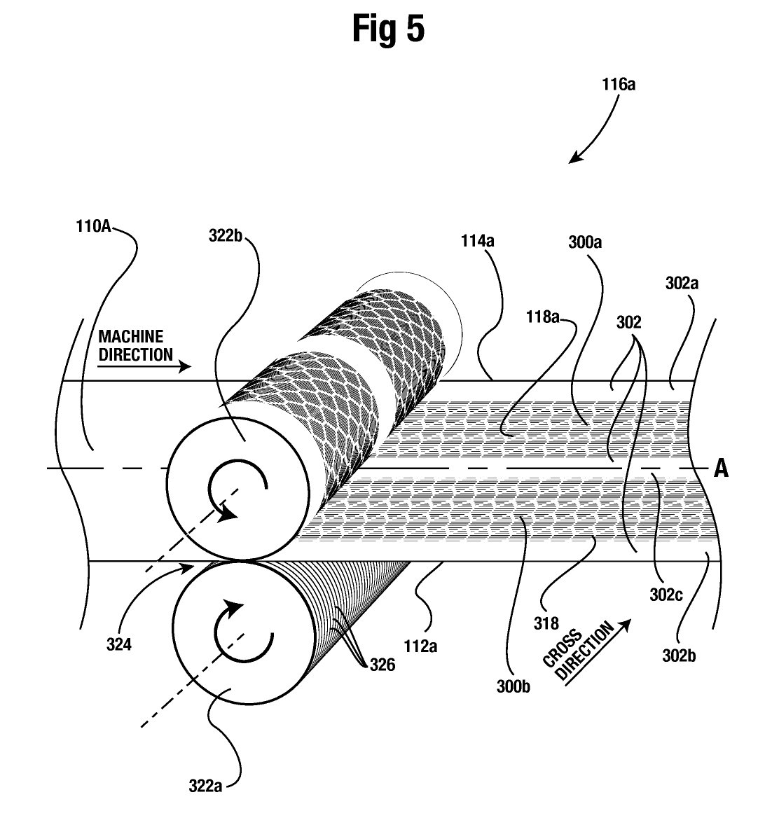

The embossing operation for applying embossed pattern 600 to a film web is discussed in FIG. 5. FIG. 5 shows the embossing operation 116a including a pair of intermeshing rollers 322a, 322b. The diameter and length of the first intermeshing roller 322a and the second intermeshing roller 322b can be equal in at least certain embodiments. As further shown in FIG. 5, the first single layer web 110a can enter nip 324 defined by the pair of intermeshing rollers 322a, 322b. The rotational axes 328a, 328b of each roller 322a, 322b can be parallel to each other and transverse to the machine direction of the single layer web 110a as shown in the figures.

As further illustrated by FIG. 5, the first intermeshing roller 322a can have a plurality of concentric ring-shaped ridges 326 and corresponding grooves extending about the circumference of the first roller 322a. The ridges 326 can be evenly dispersed about the length of the roller 322a. As explained further below, the second roller 322b can have an embossing pattern defined about its surface. The concentric ridges 326 of the first roller are constructed to intermesh with the embossing pattern of the second roller 322b. With the embossing pattern defined on the second roller 322b, as the single layer web 110a enters the nip of the intermeshing rollers 322a, 322b, the film of the single layer web 110a is embossed with the embossed pattern 600.

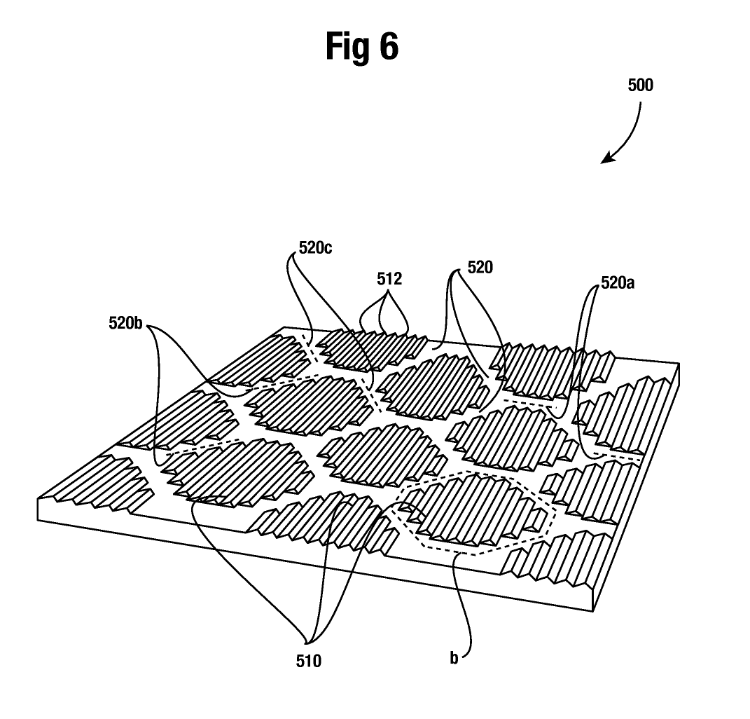

Shown in FIG. 6 is a detailed planar or flattened view of a section of the circumferential surface of the second intermeshing roller 322b. The orientation of the embossing pattern 500 is oriented approximately 90 degrees from its orientation as illustrated in FIGS. 4-5 for ease of illustration. As shown in FIG. 6, the embossing pattern 500 can have a plurality of embossment regions 510. The hexagonal shape of one of the embossment regions 510 is indicated by dashed lines B in FIG. 6, which is shown for reference only and forms no structure of the disclosed invention. As further shown in FIG. 6, each embossment region 510 can comprise a plurality of embossment ridges 512. Each of the embossment ridges can be parallel to each other and generally spaced evenly from each other.

As further shown in FIG. 6, each of the embossment regions can be bounded by a continuous embossment boundary 520. The embossment boundary can be substantially flat in relation to the embossment ridges 512 and devoid of any embossment ridges. The embossment boundary 520 can comprise first segments 520a, second segments 520b, and third segments 520c. As shown in FIG. 6, each of the three segments can extend in a different direction from each other. As should be apparent to one of ordinary skill in the art, the surface of the section illustrated in FIG. 6 necessarily follows the curvature of the surface of second roller 322b but is shown without the curvature (planar) for ease of illustration. The features of the embossing pattern 500 correspond with the emboss pattern 600 of FIG. 4. FIG. 6 is provided to illustrate the pattern on intermeshing roller 322b which results in forming the emboss pattern 600 on single layer web 110a due to the embossing operation 116a.

Now returning to FIG. 5, the embossment ridges 512 (shown in FIG. 6) of the second intermeshing roller 322b, which follows the curvature of roller 322b, are offset from the concentric ridges 326 of the first roller 322a so that the ridges of the two rollers intermesh. As illustrated in FIG. 5, once the single layer web 110a passes through the two intermeshed rollers 322a and 322b, the embossed pattern 600, as illustrated by FIG. 4, is formed onto the polymeric film of the single layer web 110a to form embossed single layer web 118a.

As shown by FIG. 5, the embossing pattern may not be applied to an entire width of single layer web 110a. Rather, pattern 600 may be applied in a plurality of partial widths, such as first and second embossed partial widths 300a and 300b, which result in a plurality of unembossed partial widths 302. FIG. 5 shows a first unembossed partial width 302b adjacent to first edge 112a, a second unembossed partial width 302a adjacent to second edge 114a, and a third unembossed partial width 302c extending between first and second embossed partial widths 300a and 300b and coextending with the centerline A of single layer web 110A. While the embossed pattern 600 is not applied to the entire width of web 110a, FIG. 5 shows the embossed pattern 600 extending continuously in the machine direction on web 110a.

It may be desirable to not emboss certain sectional widths of web 110a for various reasons. For instance, it may desirable not to emboss a partial width that is coextensive with central axis A of web 110a so as not to interfere with the folding of tube web 110a. Additionally, if the bottom edge of the resultant bags is defined by central axis A, it may desirable to not emboss this location to alleviate the risk of improperly formed embossed patterns resulting in liquid leaking from bags formed from web 110a. Furthermore, partial widths adjacent to first and second edges may not be embossed so as not to interfere with the formation of the hem in the upper area of a resultant bag and to provide an area of the bag for a user to grasp without the flexing due to the disclosed embossed pattern.

As further shown by FIG. 5, these embossed partial widths can be formed by intermeshing rollers 322a and 322b. Upper roller 322b has the embossing pattern defined about its circumference but is further shown with the pattern removed at particular locations. FIG. 5 shows three areas about roller 322b with the pattern not defined on the surface of roller 322b. Alternatively, a length of roller 322b may simply be shorter than the width of web 110a such that an area adjacent to first and second edges 112a and 114a of web 110a are not embossed.

With the embossed pattern applied to the one or more single layer webs with the linear embosses 630 extending in the machine direction and the opposing vertices aligned in the cross-direction, the embossed pattern 600 as shown in FIGS. 4-6 allows the polymeric film to expand in the cross-direction of the single layer webs. Due to the hexagonal shape of the embossed regions 610, the depicted embodiment of the embossed pattern 600 provides features to prevent tear propagation since a tear propagating in the cross direction will be interrupted by an embossed region 610.

A described above, the two rollers 322a and 322b intermesh with each other. How far the two rollers intermesh or engage with each other defines the depth of engagement (DOE) of the rollers. The magnitude of the DOE determines the depth of the embossments or how deep the film is embossed for a flexing embossed pattern 600 as disclosed by FIGS. 4-6. Because pockets of film are being stretched to a greater extent for an increased DOE, the DOE significantly affects certain physical properties of the film. A higher DOE increases the ability of the embossed film to flex and expand. A film's tear resistance and tensile strength are also affected by the DOE. With increased DOE, the machine direction tear resistance of the film increases and the machine direction tensile properties decrease. Furthermore, cross direction tear resistance dramatically decreases while the cross direction tensile properties increase as the DOE is increased.

As discussed above, the machine and cross direction tear resistance of film can be altered significantly for a film embossed with a flexing embossed pattern. In one particular example, a film comprising a LLDPE polymer with a thickness of about 0.9 mils can have a machine direction tear resistance, as according to ASTM-1922, of about 400 grams and a cross direction tear resistance of about 680 grams prior to being embossed. After embossing, the machine direction tear can be about 460 grams while the cross direction tear can be about 490 grams. Thus, a ratio of the machine to cross direction tear resistance can be in the range of about 0.5 to 0.6 for the unembossed film and about 0.9 to 1.0 for the embossed film.

The DOE, pitch, and particular pattern affect the amount an embossed film expands due to a certain applied force, as previously discussed and addressed in the '277 patent (referenced in the Background of the Invention). The amount of force required to stretch or expand the embossed film a given distance can be referred to as the force to stretch. The force to stretch can be varied by varying the DOE, pitch, and particular pattern utilized. The force to stretch may also be controlled by embossing one layer of film and not embossing a second layer of film for a two layer film.

Now returning to FIGS. 1A and 3, the embossment operations shown by these figures may utilize the same pattern and DOE. However, in certain embodiments, the pattern and/or the DOE utilized by the two embossment operations can be vary. For instance, the DOE for the second embossment 116b operation can be higher or lower than the first embossment operation 116a so that the embossed single layer webs 118a and 118b have different flexing characteristics and also other different physical properties, such as tear resistance and tensile strength. The pitch, or spacing between embossments, can also be varied between the two webs.

In certain embodiments, the entire width of each single layer web 110a and 110b can be embossed or only a partial width of one or both of the single layer webs can be embossed. In further embodiments, only a center portion of each webs width may be embossed. Furthermore, the embossed partial width of one of the webs can vary between the two webs. For instance, both webs may be embossed in their center only but the width that is embossed of the first web 110a can be less than the width that is embossed of the second web 110b. In another embodiment, first web 110a can be embossed along its center while second web 110b can be embossed adjacent to its edges and not in its center.

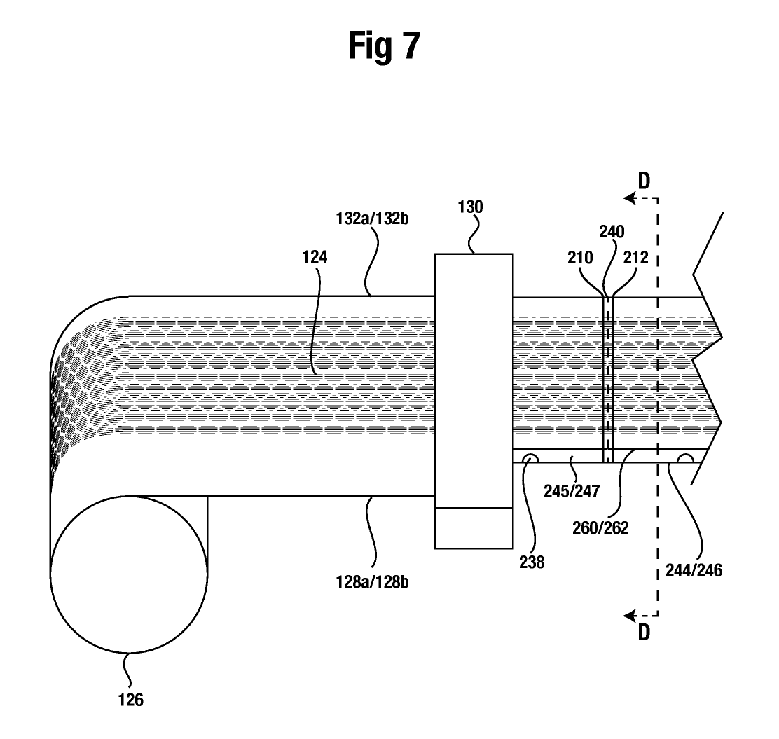

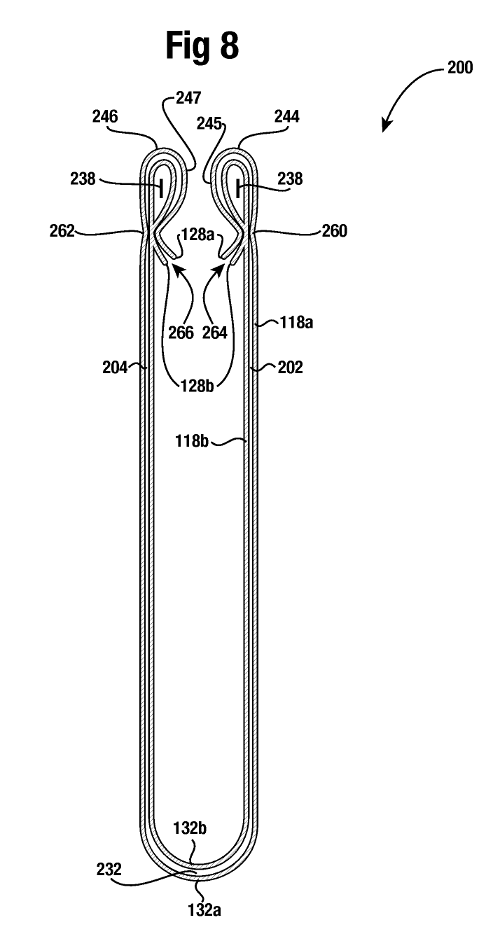

FIGS. 7 and 8 illustrate bag converting process with FIG. 7 providing a schematic perspective view and FIG. 8 providing a cross-section view after the multilayer folded web 124 is substantially converted into a plurality of drawstring bags. As shown by FIG. 7, once folded multilayer web 124 is rolled into roll stock 126 (shown by FIGS. 1A and 2-3), the roll stock 126 can be transported to converter 130 and folded multilayer web 124 can be unrolled into bag converter 130.

During bag converting shown in FIG. 7, the folded multilayer web 124 forms first panel 202 and second panel 204, with panels 202 and 204 best shown by FIG. 8. Each of the distal edges of the multilayer web, as shown in FIG. 1B, can be folded inwards toward the opposing web folds 132a and 132b as shown by FIG. 8. Further shown by FIGS. 7 and 8 are the pairs of distal edges 128a and 128b of embossed single layer webs 118a and 118b opposite from web folds 132a and 132b. Although bag 200 of FIG. 8 comprises embossed pattern 600, the resulting embossments are not shown in the figure for ease of illustration. After being folded, hems 245 and 247 are defined in the multilayer folded web and first and second top edges 244 and 246 define a top opening of bag 200. After formation of hems 245 and 247, distal edges 128a and 128b are located below edges 244 and 246 as shown in FIG. 8. Prior to or during the folding operation, drawstring 238 can be inserted within hems 245 and 247.

As further illustrated by FIGS. 7 and 8, once drawstrings 238 are inserted into hems 245 and 247, first and second hem seals 260 and 262 can be formed above the folded-in distal edges 128a and 128b. To complete the bag converting operation 130, side seals 210 and 212 along with perforations 240 are formed at pre-defined lengths extending transversely or perpendicularly along the width of the multilayer folded web 124 as shown in FIG. 7. Once the converter 130 forms side seals 210 and 212, the plurality of bags can be packaged as is known in the art. In certain embodiments, the plurality of bags can be separated at perforations 240 prior to packaging.

FIGS. 1-3 and 7 shows the forming of the multilayer web 124 performed separately from the bag converting operation 130. However, in certain embodiments, bag converting operation 130 can be performed synchronously with formation of the folded multilayer web 124. For example, rather than rolling web 124 into roll stock 126, web 124 can enter directly into converter 130 and be formed into a plurality of bags. Furthermore, the various steps can be broken down in other various ways. For example, once collapsed tube 110 of FIG. 1A is slit into single layer webs 110a and 110b, the two webs can be overlaid and rolled into roll stock. This roll stock can then be unrolled, one or both layers embossed, each layer folded, and then the multilayer web can be converted into multilayer bags.

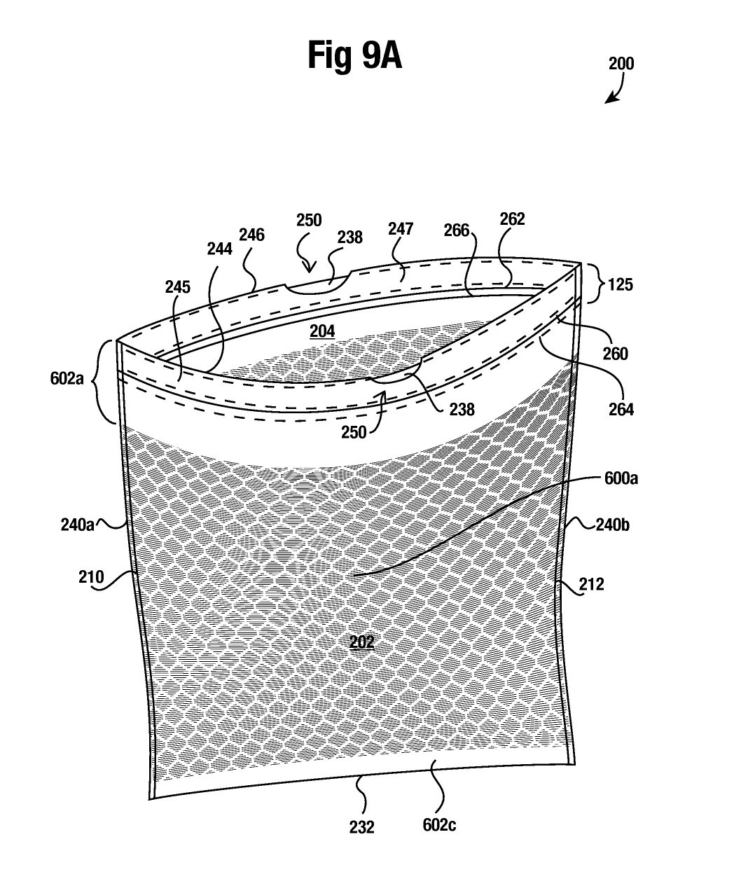

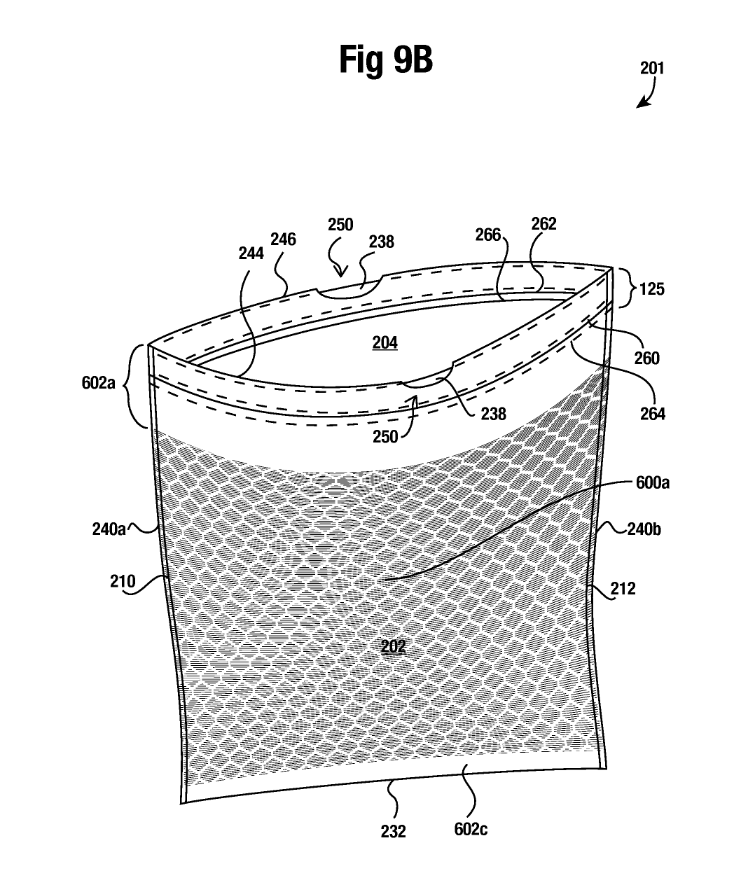

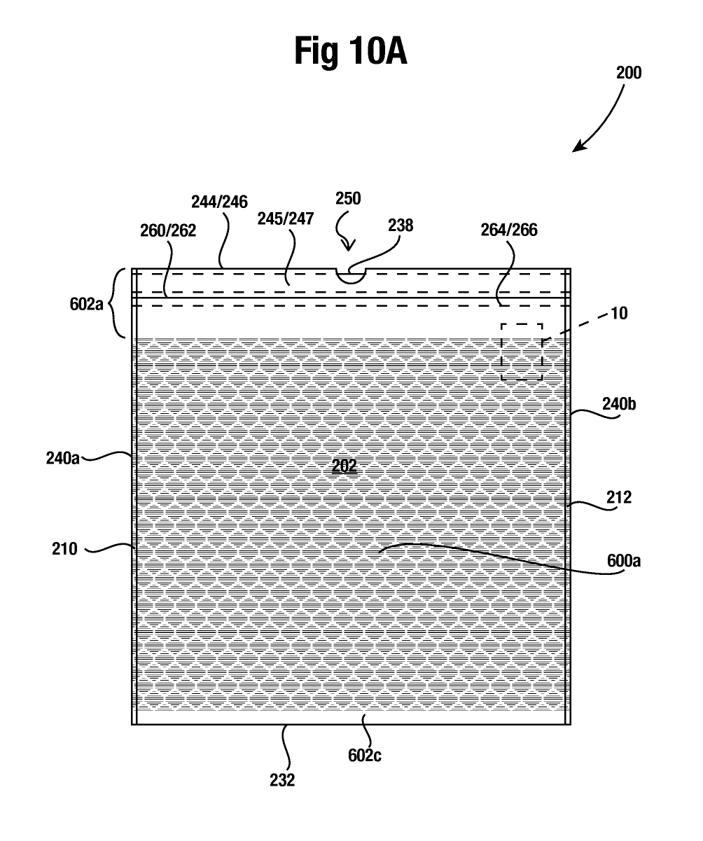

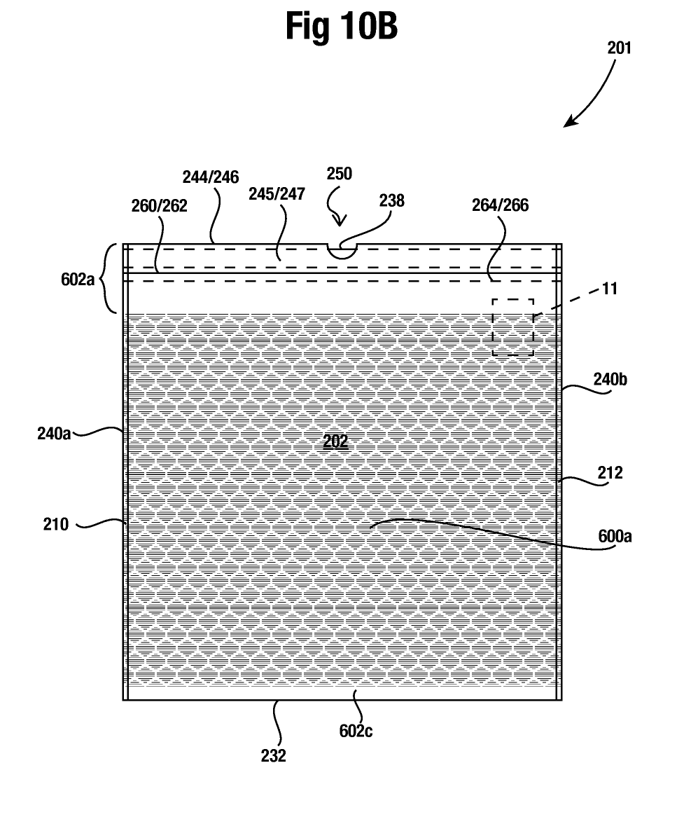

FIG. 9A provides a perspective view while FIG. 10A provides a front view of drawstring bag 200 provided by the process illustrated by FIGS. 1A and 7. FIGS. 8, 9A and 10A, show drawstring bag 200 with a front panel 202 and a back panel 204, the front panel 202 and back panel 204 being substantially rectangular in shape and joined at first side seal 210 adjacent to first side edge 240a, second seal 212 adjacent to second side edge 240b, and a bottom edge 232. First and second side edges 240a and 240b are defined by perforations 240 as illustrated in FIG. 7.

As further shown by FIGS. 9A and 10A, front panel 202 and back panel 204 can each comprise two layers of film, each panel including first and second single layer webs 118a and 118b. Hem seals 260 and 262 are shown extending from first side seal 210 to second side seal 212, each hem enclosing a drawstring 238. Below hem seals 260 and 262 are shown first and second skirts 264 and 266, each skirt comprising first and second distal edges 128a and 128b. Drawstring cutouts 250 are shown for accessing drawstrings 238. Further shown by FIG. 8 are web folds 132a and 132b of single layer webs 118a and 118b are shown forming the bottom edge 232 of the trash bag 200. Front and back panel upper edges 244 and 246 of bag 200 are shown defining the opening of the bag.

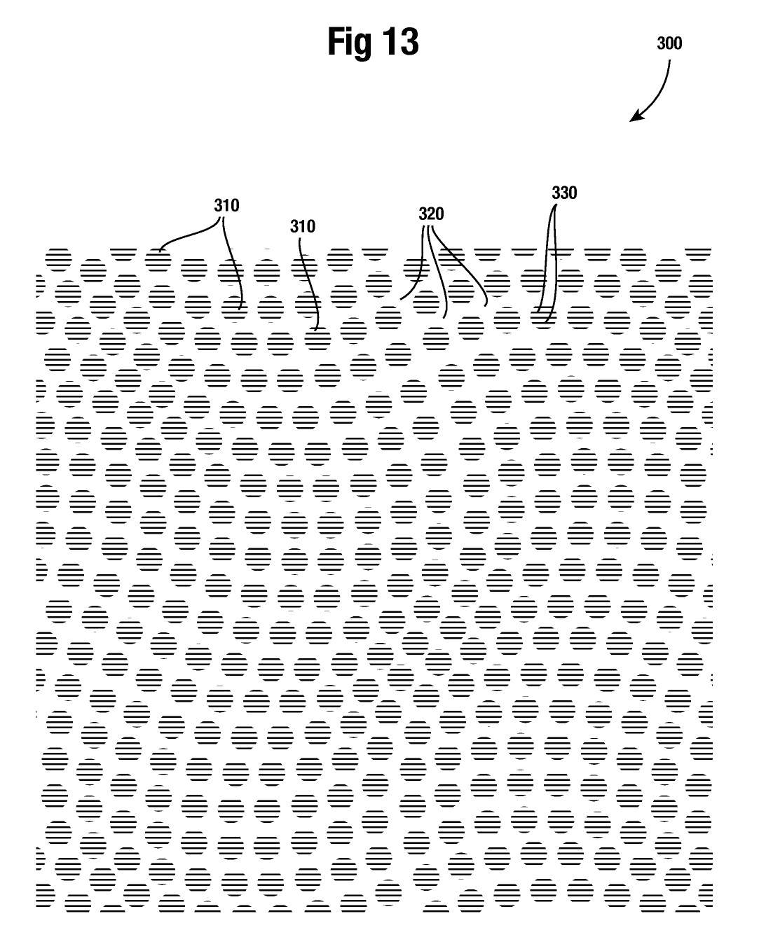

Further shown by FIG. 9A is bag 200 having a first embossed section 600a applied to first panel 202. In at least certain embodiments, embossed section 600a can comprise embossed pattern 600 as shown by FIGS. 4-6 and be applied by embossing operation 116A or 116B as discussed regarding FIGS. 1A and 2-3. In further embodiments, embossed section 600a can comprise other emboss patterns such as embossed pattern 1300 shown by FIG. 13 (discussed below).

Further shown by FIG. 9A are unembossed upper and lower sections 602a and 602c. These unembossed sections are shown extending from first side edge to second side edge. Upper unembossed section 602a is shown extending from a top edge of embossed section 600a to upper edge 244 and lower unembossed section 602c is shown extending from a lower edge of embossed section 600a to bottom edge 232 of bag 200.

FIGS. 9B and 10B provide a perspective and front view of a further embodiment of a drawstring bag according to the invention. Bag 201 is substantially similar to bag 200 of FIGS. 9A and 10A; however, only the outer layer of panels 202 and 204 are embossed as according to the FIG. 2 embodiment of the invention. Inner layer of panels 202 and 204 of FIG. 9B are not embossed and comprise generally smooth film. The remaining structure of bag 201 is the same as bag 200 and thus is not discussed further.

Due to only one layer being embossed for each panel of bag 201, the bag of FIG. 9B would require additional force to expand in comparison to the FIG. 9A embodiment; presuming that both embodiments used the same expandable embossed pattern and have otherwise similar construction. However, the FIG. 9B embodiment is expected to provide increased film strength properties over the FIG. 9A embodiment. Furthermore, due to the FIG. 9B embodiment's additional force to stretch, it can provide additional load carrying capacity in comparison to the FIG. 9A embodiment.

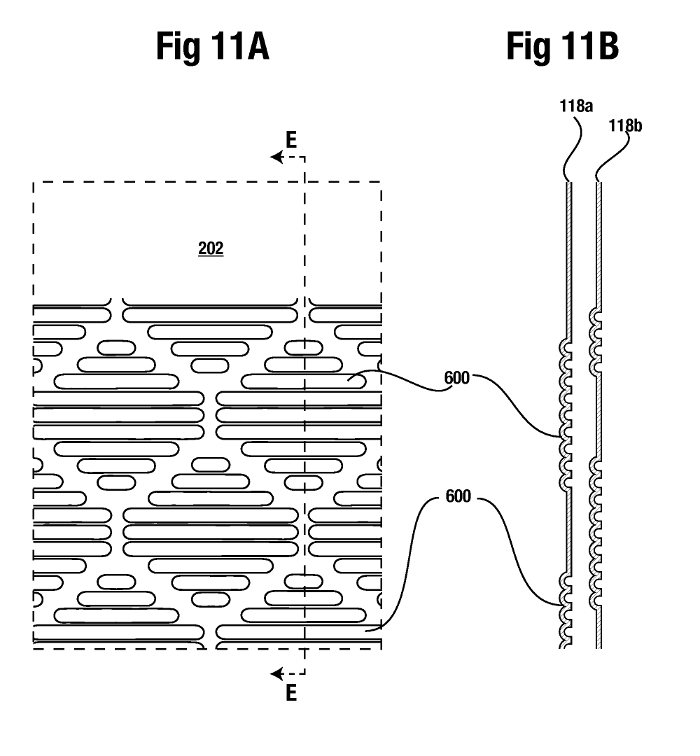

Now turning to FIGS. 11A and 11B, magnified views of a section of panel 202 of bag 200 is shown. FIG. 11A provides a front view of a section of panel 202 while FIG. 11B provides a cross-sectional view of the panel. FIGS. 11A and 11B illustrate in detail the resultant embossed pattern on panel 202 due to the embossing operations of either FIG. 1 or FIG. 3. The figures shows that each of the single layer webs 118a and 118b are embossed with the embossed pattern 600 of FIG. 4. FIG. 11A only shows the first single layer web 118A which forms the front outer first layer of panel 202; the second single layer web 118b, the inner layer of panel 202, is not shown for purposes of clarity. However, unlike FIG. 11A, FIG. 11B shows both single layer webs 118a and 118b, with the two single layers 118a and 118b forming the two layers of multilayer panel 202.

As shown by FIG. 11B, the embossed pattern 600 applied to web 118b is offset from the embossed pattern 600 applied to 118a. The two embossed patterns of the two webs are offset because each pattern is formed separately with no alignment between the two patterns. FIG. 11B further shows that due to single layer webs 118a and 118b being embossed separately, the embossed patterns 600 of the two webs are not intermeshed with each other; rather, the embossed patterns of the two layers are disengaged from each other.

FIG. 11B shows that the embossed pattern 600 is applied to both webs 118a and 118b in the same direction. However, in further embodiments, the embossed pattern may be applied in different directions between the two webs 118a and 118b. For instance, FIG. 11B shows embossments in both single layers 118a and 118b so that a plurality of concave depressions are defined in the right hand side of each layer. In a further embodiment with the embossing performed in opposite directions for each layer, a first layer would have concave depressions on its right side and the second layer would have concave depressions on its left side.

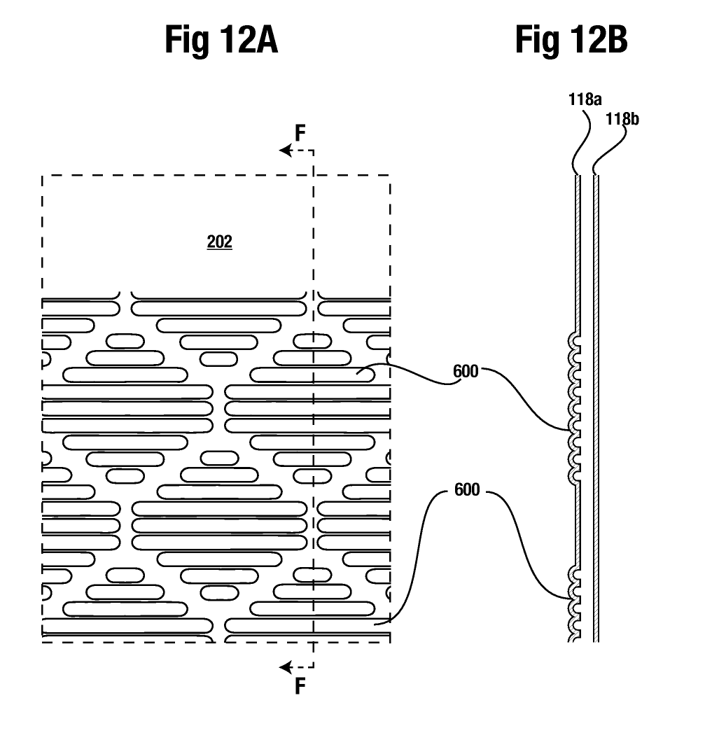

Provided by FIGS. 12A-12B are magnified views of a section of bag 201 of FIGS. 9B and 10B. FIG. 12A provides a front view of a section of panel 202 of bag 201 while FIG. 12B provides a cross-sectional view of the panel. As best shown by FIG. 12B, first single layer web 118a is embossed with embossed pattern 600 while second single layer web 118b is not embossed and is generally smooth. FIG. 12A only shows the first single layer web 118A which forms the front outer first layer of panel 202. The second single layer web 118b, the inner layer of panel 202, is not shown. FIG. 12B shows both single layer webs 118a and 118b, with the two single layers 118a and 118b forming the two layers of multilayer panel 202.

FIG. 13 shows an additional embossed pattern that may be applied to one or both of the first and second single layer webs 110A and 110b. As shown by FIG. 13, embossed pattern 1300 has a variety of circular embossed regions 1310 arranged along a series of parallel sinusoidal paths separated by a continuous, unembossed arrangement 1320. In this continuous unembossed arrangement 1320, a continuous straight-line path is generally not possible, assuming the size of the embossed regions 1310 are properly sized, the amplitude of the sinusoidal path is sufficiently large, and there is sufficient frequency of the embossed regions 1310 along the sinusoidal path. Thus, as a tear propagates across the film, it will necessarily intersect with one of the embossed regions 1310. Such tears will have a tendency to propagate around the edges of the embossed regions 1310 and into varying directions.

In the embodiment disclosed in FIG. 13, the embossed regions 1310 are preferably arranged along a series of parallel, sinusoidal paths extending in a first direction. The peak amplitude, measured from the center of the sinusoidal wave to the peak of the sinusoidal wave is typically at least one-half the diameter of the embossed regions 1310. In some embodiments of the present invention, the embossed regions 1310 are also arranged along a sinusoidal path extending in a second direction. The second direction may be perpendicular to the first direction of the sinusoidal path.

In a preferred embodiment of the embossed pattern 1300, the embossed regions 1310 will all be substantially the same size. However, in other embodiments, the size of the embossed regions 1310 may vary. For example, depending on the spacing between nearby embossed regions 1310, the size, or even the shapes, of the embossed regions may be modified to provide spacing between the embossed regions that is more uniform.

As previously noted, the specific embodiments depicted herein are not intended to limit the scope of the present invention. Indeed, it is contemplated that any number of different embodiments may be utilized without diverging from the spirit of the invention. Therefore, the appended claims are intended to more fully encompass the full scope of the present invention.

What is claimed is:

1. A multilayer bag comprising:
a front panel and a rear panel, the front panel and rear panel joined adjacent to a first side edge by a first side seal and adjacent to an opposite second side edge by a second side seal,
the front and rear panels each comprising inner and outer layers of polymeric film, the inner and outer layers formed from first and second single layer webs,
the first and second single layer webs folded generally along a centerline extending in the machine direction of the first and second webs to form a bottom edge of the multilayer bag, the first single layer web folded within the second single layer web,
the inner layer having a first embossed pattern and the outer layer having a second embossed pattern, the first and second embossed patterns each comprising a plurality of embossed regions, each embossed region separated by a continuous unembossed arrangement and comprising a plurality of embosses of varying length,
each embossed pattern formed separately such that the first and second embossed patterns are offset and not intermeshed with each other,
the front panel and rear panel joined at a bottom edge, and
an opening of the bag defined by an upper edge of the front and rear panels.

2. The multilayer bag of claim 1 further comprising:
the first and second single layers webs formed from a single collapsed tube of polymeric film, the collapsed tube formed via blown film extrusion.

3. The multilayer bag of claim 1 further comprising:
the first and second webs formed from two separate collapsed tubes of polymeric film.

4. The multilayer bag of claim 1 further comprising:
the first embossed pattern different from the second embossed pattern.

5. The multilayer bag of claim 4 further comprising:
the first embossed pattern having a different depth of engagement from the second embossed pattern.

6. The multilayer bag of claim 5 further comprising:
the first and second embossed patterns extending continuously from the first side edge to the second side edge of the multilayer bag, and
the first and second embossed patterns having first and second heights, the first height different from the second height.

7. The multilayer bag of claim 3 further comprising:
a material composition of the first web different from a material composition of the second web.

8. A multilayer bag comprising:
a front panel and a rear panel, the front panel and rear panel joined adjacent to a first side edge by a first side seal and adjacent to an opposite second side edge by a second side seal,
the front and rear panels each comprising first and second layers of polymeric film,
the first and second layers formed from separate first and second single layer webs, each of the single layer webs formed from one or more collapsed tubes of polymeric film, each of the single layer webs having a centerline extending in a machine direction,
the first layer of the front and rear panels having an embossed pattern, the embossed pattern comprising a plurality of embossed regions, each embossed region separated by a continuous unembossed arrangement and comprising a plurality of embosses of varying length, the second layer of the front and rear panels not having an embossed pattern,
the front panel and rear panels joined at a bottom edge, the bottom edge corresponding generally to the centerline of the first and second webs, and
an opening of the bag defined by an upper edge of the front and rear panels.

9. The multilayer bag of claim 8 further comprising:
the one or more collapsed tubes comprising first and second collapsed tubes,
each collapsed tube slit and unfolded to form one of the first and second single layer webs, and
each collapsed tube formed by blown film extrusion.

10. The multilayer bag of claim 8 further comprising:
the first and second single layer webs formed from opposing sides of a single collapsed tube of polymeric film.

11. The multilayer bag of claim 10 further comprising:
the embossed pattern comprising a flexing embossed pattern.

12. The multilayer bag of claim 11 further comprising:
the first layer having a machine to cross direction tear resistance ratio of about 0.9 to 1.0, and
the second layer having a machine to cross direction tear resistance ratio of about 0.5 to 0.6.

13. The multilayer bag of claim 12 further comprising:
the embossed pattern comprising at least two separate partial heights of the multilayer bag.

14. A method of forming a multilayer polymeric bag comprising:
embossing a first web of continuous film with a first embossed pattern, the first embossed pattern comprising a plurality of embossed regions, each embossed region separated by a continuous unembossed arrangement and comprising a plurality of embosses of varying length, the first web having only a single layer, the first web having a machine direction and a cross direction, the first web having a first edge opposite from a second edge in the cross direction, the first web having a first web width extending in the cross direction,
after the first web is embossed, placing a second web of continuous film over the first web, the second web having only a single layer of smooth unembossed and un-stretched film, the second web having a machine direction and a cross direction, the second web having a first edge opposite from a second edge in the cross direction, the second web having a second web width extending in the cross direction,
overlaying the first web with the second web with the first edges of the first and second webs adjacent to each other and the second edges of the first and second webs adjacent to each other,
folding the overlaid first and second webs in half so that a centerline in the machine direction of both webs generally corresponds with the fold formed in the first and second webs to form first and second folded webs, and
converting the first and second folded webs into bags.

15. The converting of the first and second folded webs into bags of claim 14 further comprising:
defining a bottom edge of the bags at the centerline of both folded webs,
placing a plurality of pairs transverse seals in the folded webs to define side seals, and
placing a plurality of perforations between each pair of side seals to define side edges of the bags.

16. The method of claim 14 further comprising:
the embossing of the first web extending only a partial width of the first web width.

17. The method of claim 16 further comprising:
the embossing of the first web comprising at least two separate partial widths of the first web width.

18. The method of claim 14 further comprising:
the first and second single layer webs formed from a single collapsed tube of blown polymeric film.

19. The method of claim 14 further comprising:
the first and second layer webs formed from two different collapsed tubes of blown polymeric film.

20. The method of claim 16 further comprising:
embossing the second web of continuous film separately from the first web.
